(19) United States
(12) Patent Application Publication
(10) Pub. No.: US 2026/0274395 A1
(43) Pub. Date: Sep. 17, 2026

(54) INPUT OBJECTIVE-BASED WING ASSEMBLY PITCH ADJUSTMENTS

(71) Applicant: Toyota Motor Engineering & Manufacturing North America, Inc., Plano, TX (US)

(72) Inventors: Tom M. Neuman, Fairfax, VA (US); Frank K. Kozel, Glen Burnie, MD (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/395,300

(22) Filed: Nov. 20, 2025

Related U.S. Application Data
(60) Provisional application No. 63/770,538, filed on Mar. 12, 2025.

(51) Int. Cl. B64C 3/38; B64C 29/00

(52) U.S. Cl. CPC B64C 3/385; B64C 29/0008

(57) ABSTRACT

Systems, methods, and other embodiments described herein relate to improving lift and efficiency in an aircraft by adjusting the pitch of a wing assembly in a variable incidence wing aircraft. In one embodiment, a method includes determining, based on an input objective, a target wing assembly pitch for a wing assembly of an aircraft. The wing assembly of the aircraft rotates about a pitch axis of the fuselage via action of a tilt actuator. The method also includes measuring a wing assembly pitch of the wing assembly. The method also includes altering an angle of the wing assembly based on a difference between the target wing assembly pitch and the wing assembly pitch.

### CROSS-REFERENCE TO RELATED APPLICATIONS

This application claims the benefit of U.S. Provisional Application No. 63/770,538, filed on Mar. 12, 2025, which is herein incorporated by reference in its entirety.

### TECHNICAL FIELD

The subject matter described herein relates, in general, to variable incidence wing aircraft and, more particularly, to adjusting the angle of a wing assembly based on a target pitch for the wing assembly of the aircraft.

### BACKGROUND

In an airplane, lift is created as air travels over the wing while the airplane moves forward. Specifically, air over the top surface of the wing travels more quickly, creating lower pressure, while air below the bottom surface of the wing moves more slowly, creating higher pressure. This pressure differential generates an upward force known as lift.

Variable incidence wing aircraft have wings that pivot about a pitch axis of the fuselage via the action of a tilt actuator, such as a jackscrew or other tilt actuator. In a variable incidence wing, the pitch angle of the wing assembly may be different than the pitch angle of the fuselage. All other degrees of freedom (roll, yaw, heave, sway, surge) may be rigidly connected between the fuselage and wing. Propellers, or another thrust source, may be attached to the wings, fuselage, or elsewhere on the aircraft to drive the aircraft. These aircraft may enhance maneuverability and facilitate unique flight modes, including vertical and horizontal flight.

### SUMMARY

In one embodiment, example systems and methods relate to a manner of improving the lift and efficiency of a variable incidence wing aircraft. In one embodiment, a tilt actuator control system is disclosed. The control surface control system includes a processor and a memory storing machine-readable instructions that, when executed by the processor, cause the processor to determine, based on an input objective, a target wing assembly pitch for a wing assembly of an aircraft. The wing assembly of the aircraft rotates about a pitch axis of the fuselage via action of a tilt actuator. The memory also stores machine-readable instructions that, when executed by the processor, cause the processor to measure a wing assembly pitch of the wing assembly. The memory also stores machine-readable instructions that, when executed by the processor, cause the processor to alter an angle of the wing assembly based on a difference between the target wing assembly pitch and the wing assembly pitch.

In one embodiment, a non-transitory machine-readable medium is disclosed. The non-transitory machine-readable medium includes instructions that, when executed by the processor, cause the processor to determine, based on an input objective, a target wing assembly pitch for a wing assembly of an aircraft. The wing assembly of the aircraft rotates about a pitch axis of the fuselage via action of a tilt actuator. The medium also includes instructions that, when executed by the processor, cause the processor to measure a wing assembly pitch of the wing assembly. The medium also includes instructions that, when executed by the processor, cause the processor to alter an angle of the wing assembly based on a difference between the target wing assembly pitch and the wing assembly pitch.

In one embodiment, a method for improving the lift and efficiency of a variable incidence wing aircraft is disclosed. In one embodiment, the method includes determining, based on an input objective, a target wing assembly pitch for a wing assembly of an aircraft. The wing assembly of the aircraft rotates about a pitch axis of the fuselage via action of a tilt actuator. The method also includes measuring a wing assembly pitch of the wing assembly. The method also includes altering an angle of the wing assembly based on a difference between the target wing assembly pitch and the wing assembly pitch.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an aircraft within which systems and methods disclosed herein may be implemented.

FIGS. 2A and 2B illustrate the operation of a tilt actuator of the aircraft within which systems and methods disclosed herein may be implemented.

FIG. 3 illustrates one embodiment of a tilt actuator control system that is associated with altering the angle of a wing assembly, according to an embodiment of the principles described herein.

FIG. 4 illustrates a flowchart for one embodiment of a method that is associated with altering the angle of a wing assembly, according to an embodiment of the principles described herein.

FIGS. 5A-5C are side views of an aircraft with wing assembly pitch adjustments to increase lift, according to an embodiment of the principles described herein.

FIGS. 6A-6C are side views of an aircraft with wing assembly pitch adjustments to decrease lift, according to an embodiment of the principles described herein.

FIGS. 7A-7B are side views of an aircraft with fuselage pitch adjustments while the wing assembly is maintained in a pitched-up orientation, according to an embodiment of the principles described herein.

FIG. 8 depicts a control loop that adjusts the wing assembly pitch based on a target fuselage pitch, according to an embodiment of the principles described herein.

FIG. 9 depicts a control loop that adjusts the fuselage pitch and wing assembly pitch based on a target load factor, according to an embodiment of the principles described herein.

FIG. 10 depicts a control loop that adjusts the wing assembly pitch to achieve a target energy consumption, according to an embodiment of the principles described herein.

FIG. 11 depicts a control loop that adjusts the wing assembly pitch based on a measurable factor, according to an embodiment of the principles described herein.

### DETAILED DESCRIPTION

Systems, methods, and other embodiments associated with improving the lift and efficiency of a variable incidence wing aircraft, where the wing assembly rotates about the pitch axis of the fuselage via an actuator such as a tilt actuator (e.g., a jackscrew).

In an aircraft, a pilot (whether in-cabin or remote) may adjust the position of control surfaces to manipulate the aircraft attitude (i.e., pitch, roll, and yaw) during flight. In general, a control surface manipulates airflow to generate aerodynamic forces that change the aircraft direction and/or attitude (e.g., pitch, yaw, and roll). For example, as a pilot, whether onboard the aircraft or from a remote location, inputs a control command at a control yoke, control stick, remote control joystick, or the like, a controller deflects the control surfaces to alter the direction of air and generate forces that move the aircraft. There are various control surfaces, including elevators, ailerons, rudders, flaps, spoilers, stabilators, elevons, trim tabs, and canards.

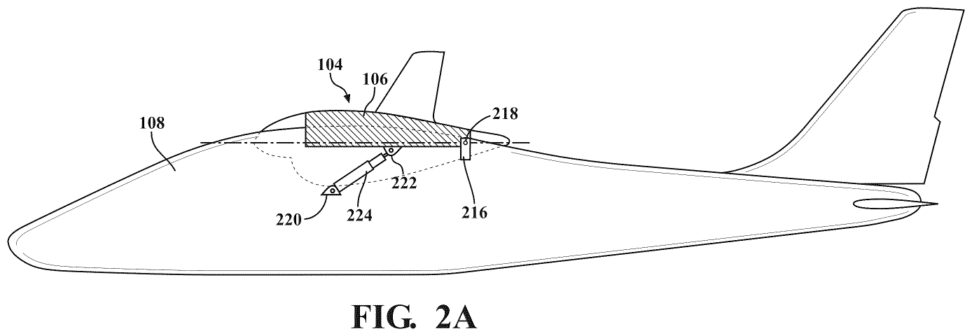

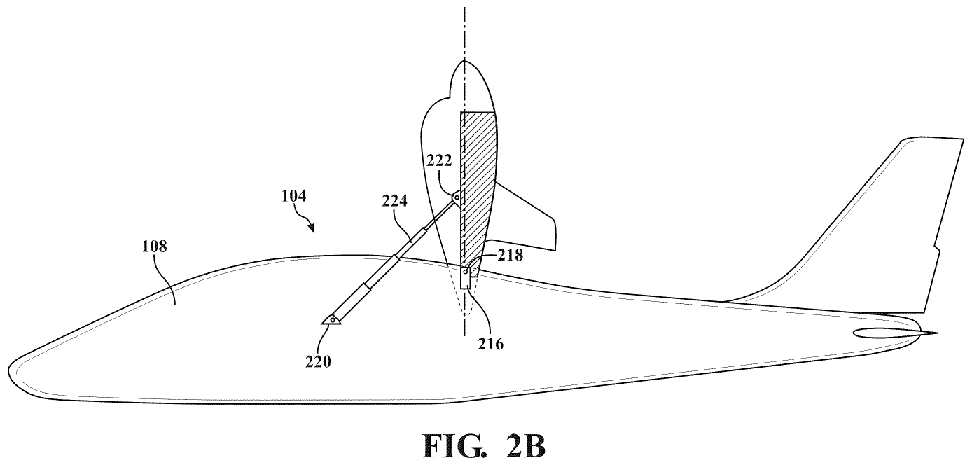

In some aircraft, referred to as variable incidence wing aircraft (e.g., a tilt-wing aircraft), the wing assembly pitch may be controlled in flight to differ from the fuselage pitch. That is, there may be a variable incidence angle between the wing assembly longitudinal axis and the fuselage longitudinal axis. In these examples, the aircraft may include a tilt actuator that changes the incidence angle of the wing assembly. An example of a tilt actuator is depicted in FIGS. 2A and 2B of the present application. Note that in this example, the manipulation of a control surface may alter the pitch angle of both the wing assembly and the fuselage, while activation of a wing actuator changes the incidence angle of the wing assembly. It should be noted that activation of the wing actuator may provide some nominal alteration of the fuselage pitch angle, due to the changed airflow over the wing assembly.

Fixed-wing aircraft are flown such that the wing assembly and fuselage have a fixed pitch angle difference. Even variable incidence wings, while having wing-fuselage incidence during transition periods, such as during landing, take-off, or transitioning from vertical flight to horizontal flight (as may occur with a vertical take-off and landing (VTOL) aircraft known as a tilt-wing), may have pre-selected incidence arrangements that are fixed and not dynamically adjustable based on input objectives. For example, other variable incidence wing aircraft, during horizontal flight, may fly with a pre-selected incidence arrangement where the wing assembly and fuselage pitches are matched.

However, it should be noted that having the fuselage level with the wing assembly may not always be the optimal solution for maximizing efficiency. That is, in some cases, flight dynamics (e.g., lift, fuel consumption, etc.) may be improved when the aircraft is flown with a non-zero incidence (i.e., a non-zero angle between the wing assembly longitudinal axis and the fuselage longitudinal axis). Put another way, operating any aircraft, even a variable incidence wing aircraft, with pre-selected fuselage and wing pitch alignment may decrease the overall aircraft lift or efficiency in certain circumstances, and it may be desirable to fly the aircraft with misaligned wing assembly and fuselage longitudinal axes that are actively controlled during horizontal flight, cruising flight, and while performing maneuvers. The active incidence control of a tilt-wing aircraft during transition from vertical (i.e., hover) to horizontal flight is a separate function that does not relate to horizontal, cruising, non-transitional flight lift or efficiency.

Moreover, some types of flight may not be possible with fixed-wing and other variable-incidence wing aircraft. For example, at slow speeds, the lift generated by an aircraft may be insufficient to overcome the forces of gravity. The current system, by comparison, may provide increased lift by adjusting the wing assembly pitch angle to generate more lift, thereby facilitating this type of flight that would otherwise be impossible. Accordingly, the present system increases the lift or efficiency of a variable incidence wing aircraft by controlling the pitch angle of the wing assembly.

In some examples, in addition to altering the wing assembly pitch to increase lift and/or efficiency, the present system may further increase lift and efficiency by further adjusting the fuselage pitch via a control surface. Specifically, a wing angle of attack and its total lift are limited by aerodynamic stall. However, the fuselage may be able to sustain much higher angles of attack before loss of lift. This can be used to further increase lift, beyond what is achieved by altering the wing assembly pitch, which helps the airplane fly at low speeds or high bank angles. The aircraft may be flown in the opposite arrangement, where the fuselage is pitched more negatively than the wing to increase downforce or deceleration.

Accordingly, the present specification describes a system that provides automatic and active control of the wing pitch angle during cruising, horizontal, and non-transitional flight, based on an input objective, such as a desired load (lift) factor, energy consumption data, etc. The system then alters the wing assembly pitch angle (via a jack-screw) and/or the fuselage pitch angle (via control surfaces) to achieve a target incidence between the wing assembly and the fuselage.

Specifically, the system determines an input objective, such as reduced energy consumption, increased lift, decreased lift, a level fuselage attitude, or slower flight speed, among others. Based on this input objective, the system determines the target wing assembly pitch for the aircraft wing assembly during horizontal flight and measures the actual pitch angle of the wing assembly. Through the action of a tilt actuator, such as a jackscrew, the system adjusts the wing assembly pitch angle to achieve the target wing assembly pitch.

The target wing assembly pitch may be determined in a variety of ways. In different examples, the target wing assembly pitch may be one that 1) maintains the fuselage at a fixed pitch angle which is level to the earth's surface, 2) minimizes energy consumption (e.g., battery current or fuel flow), or 3) increases lift in low-speed flight.

In an example, the tilt actuators may be managed by a flight controller, which can be switched between modes. Each mode activates the tilt actuators to achieve a desired objective. For example, the flight controller may switch between 1) a mode for minimizing energy consumption, 2) a mode for holding the fuselage level regardless of energy consumption, 3) a mode for increasing lift in low-speed flight at the cost of efficiency, or 4) a mode for decreasing lift in high-speed flight, etc. As such, the present tilt actuator control system increases the lift and fuel/operational efficiency of aircraft where the wing assemblies of the aircraft rotate from the fuselage about a pitch axis via a tilt actuator, by changing the pitch angle of the wings to set the wing assembly pitch to a target value, which target value may be defined by some input objective.

As used in the present specification and in the appended claims, the term “pitch angle” may refer to an angle between the horizon and the longitudinal axis of a wing assembly or the fuselage. Moreover, “aircraft pitch” and “fuselage pitch” may be used interchangeably, as an onboard pilot or remote pilot sensor system may both be located in the fuselage.

Moreover, as used in the present specification and in the appended claims, the term “angle of attack” may refer to an angle between the relative wind and the longitudinal axis of the wing assembly or fuselage. For example, an aircraft can be level to the horizon (i.e., have a level pitch) while descending, which may cause some relative wind from below, thereby inducing a positive angle of attack.

Lastly, as used in the present specification and in the appended claims, the term “angle of incidence” may refer to the angle between the wing assembly longitudinal axis and the fuselage longitudinal axis, regardless of the aircraft pitch or angle of attack.

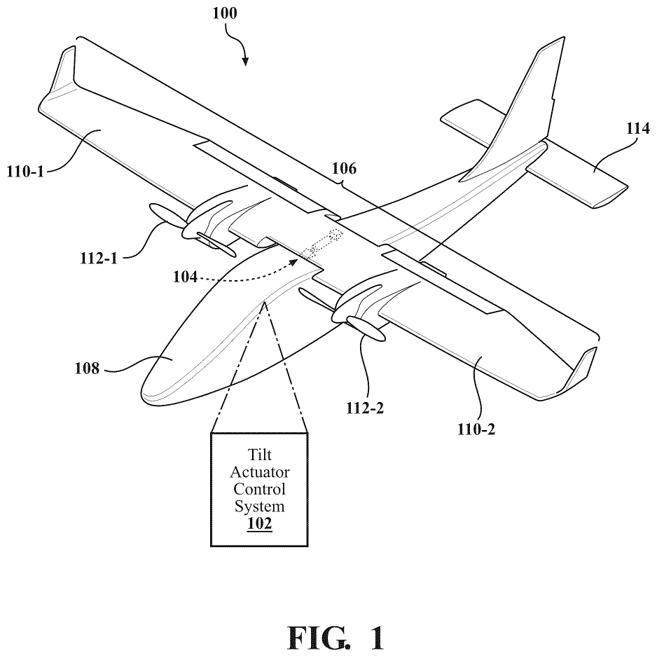

Turning now to the figures, FIG. 1 illustrates one embodiment of an aircraft 100 within which systems and methods disclosed herein may be implemented. It will be appreciated that, for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the aircraft 100 includes a tilt actuator control system 102 that is implemented to perform methods and other functions as disclosed herein relating to enhancing the lift and efficiency of an aircraft via wing assembly alterations.

In general, the aircraft 100 includes a fuselage 108, or body, in which mechanical, electrical, and/or control systems are housed. As described above, the aircraft 100 may have a variety of uses, and the flight control components specific to the particular use may be housed within the fuselage 108. As a particular example, the aircraft 100 may be unmanned. In this case, the fuselage 108 houses a communication system for receiving and executing commands from a remote operator. In another example, the aircraft 100 is locally operated by a pilot on board. In this example, the fuselage 108 includes a cockpit where the pilot sits to control the aircraft 100.

The aircraft 100 also includes a pair of wings 110-1 and 110-2 extending away from the fuselage 108. The wings 110-1 and 110-2 in combination may be referred to as a wing assembly 106. In one specific example, the aircraft 100 is a variable incidence wing aircraft in which the wing assembly 106 rotates independently about a pitch axis of the fuselage 108 of the aircraft 100. In this example, articulation of the wing assembly 106 is via the tilt actuator 104. FIGS. 2A and 2B illustrate the operation of the tilt actuator 104, which changes the incidence between the wing assembly 106 and the fuselage 108. In one example, the wings 110-1 and 110-2 of the variable-incidence wing aircraft are rigidly coupled to one another, such that the entire wing assembly 106 rotates as a single unit via the tilt actuator. In another example, each wing 110-1 and 110-2 is independently rotatable. In this example, the aircraft 100 may be equipped with two tilt actuators, one per wing 110-1 and 110-2.

The aircraft 100 also includes a thruster, which, in the example depicted in FIG. 1, includes propellers 112-1 and 112-2 mounted to respective wings 110-1 and 110-2. A thruster is any device or engine that generates thrust to move or control the aircraft 100. While FIG. 1 depicts propellers 112-1 and 112-2 as the thrust sources, the aircraft 100 may include various types of thrust sources, such as jet engines and ducted fans, among others, or may be an unpowered glider without any thrusters.

As described above, the aircraft 100 may include any number of control surfaces. For example, the aircraft 100 may include ailerons on respective wings 110-1 and 110-2. As another example, the aircraft 100 may include a stabilator 114 on the tail of the aircraft 100.

The control surfaces change the airflow around the aircraft 100. Changes in the airflow around the aircraft generate aerodynamic forces that move the aircraft 100 during flight. That is, when a pilot issues a flight command, these control surfaces deflect and alter the aircraft-guiding aerodynamic forces to change the attitude of the aircraft to follow the pilot's command. For example, in a fixed-wing aircraft, a pilot may pull backward on a control yoke to initiate a climb. Responsive to this input, the stabilator 114 or elevator deflects its trailing edge upward, generating a downward force on the tail of the aircraft. The downward force on the tail pitches the nose of the fixed-wing aircraft up.

In general, deflecting the tail end of the elevator or stabilator 114 up generates a downward force on the tail of the fuselage 108. The downward tail force pitches the nose of the fuselage 108 upward. Note that while the wing assembly 106 may have incidence relative to the fuselage 108, such variable incidence may function separately from the stabilator 114. Any alteration of the fuselage pitch (i.e., via a deflection of the stabilator 114, elevator, or other pitch-altering control surface) may simultaneously alter the pitch of the fuselage 108 and of the wing assembly 106 if the incidence angle between them is not altered.

As such, the fuselage pitch may be controlled by moving an entire stabilator 114, or a rear portion of a horizontal stabilizer referred to as an elevator, or a trim tab. Note that while FIG. 1 depicts ailerons and a stabilator 114, the aircraft 100 may include other types of control surfaces such as canards, trim tabs, spoilers, elevons, and a rudder. Accordingly, while FIG. 1 and others depict a stabilator 114 as the deflected control surface on the fuselage 108, the tilt actuator control system 102 may adjust the deflection of any control surfaces that change the pitch of the fuselage 108.

The aircraft 100 may be equipped with a tilt actuator 104. Generally, the tilt actuator 104 operates to adjust the pitch angle of the wing assembly 106 relative to the fuselage 108. The tilt actuator 104 enables the variable incidence flight mode of the aircraft 100. FIGS. 2A and 2B depict the operation of the tilt actuator 104 to change the pitch angle of the wing assembly 106.

As described in greater detail below, the tilt actuators 104 may be operated under the control of the tilt actuator control system 102. That is, in general, the tilt actuator control system 102 adjusts the wing assembly pitch angle by activating the tilt actuator 104 as described in FIGS. 2A and 2B. Specifically, as described in more detail below, the tilt actuator control system 102 determines a target wing assembly pitch based on an input objective (e.g., reduced fuel consumption or reduced drag) and adjusts the position of the wing assembly 106 to achieve the target wing assembly pitch.

FIGS. 2A and 2B illustrate the operation of a tilt actuator 104 of the aircraft 100, within which systems and methods disclosed herein may be implemented. As described above, and as depicted in FIGS. 2A and 2B, the tilt actuator 104 operates to change the pitch angle of the wing assembly 106. The tilt actuator 104 may operate through any range of motion. That is, the tilt actuator 104 may change the incidence of the wing assembly 106, relative to the fuselage 108, from 0 degrees as depicted in FIG. 2A to 90 degrees of incidence as depicted in FIG. 2B. Note that while FIGS. 2A and 2B depict a particular range of motion of the wing assembly 106 (e.g., 90 degrees), the tilt actuator 104 may be able to change the incidence to greater than 90 degrees, for example, to 100 degrees or more.

In an example, the wing assembly 106 may be rotatably mounted to the fuselage 108 via a pivot support 216. That is, the pivot support 216 may be rigidly mounted to a surface of the aircraft fuselage 108. A bearing 218 or other pivoting device couples the wing assembly 106 to the pivot support 216 and defines a pivot axis for the wing assembly 106. That is, the wing assembly 106 rotates about the bearing 218 when transitioning between a generally horizontal pitch angle and a generally vertical pitch angle.

An actuator, such as a piston 224, joins the wing assembly 106 to the fuselage 108. Specifically, the piston 224 is coupled to the wing assembly 106 via a wing support 222 and is coupled to the fuselage 108 via a fuselage support 220. Each of these supports includes a bearing that allows the respective end of the piston 224 to rotate as the piston 224 actuates the wing assembly 106 from the generally horizontal position depicted in FIG. 2A to the generally vertical position depicted in FIG. 2B.

The piston generally includes a rod that extends in and out of a cylinder. Based on a command received from the tilt actuator control system 102, a valve is activated, directing pressurized fluid into one end of the piston 224. The hydraulic pressure pushes the rod out of the cylinder, which presses against the wing assembly 106, creating the rotational motion of the wing assembly 106 depicted in FIGS. 2A and 2B. Note that while FIGS. 2A and 2B depict a 90-degree adjustment of the wing assembly 106, the tilt actuator control system 102 may adjust the wing assembly 106 through smaller ranges of motion, as depicted in later figures.

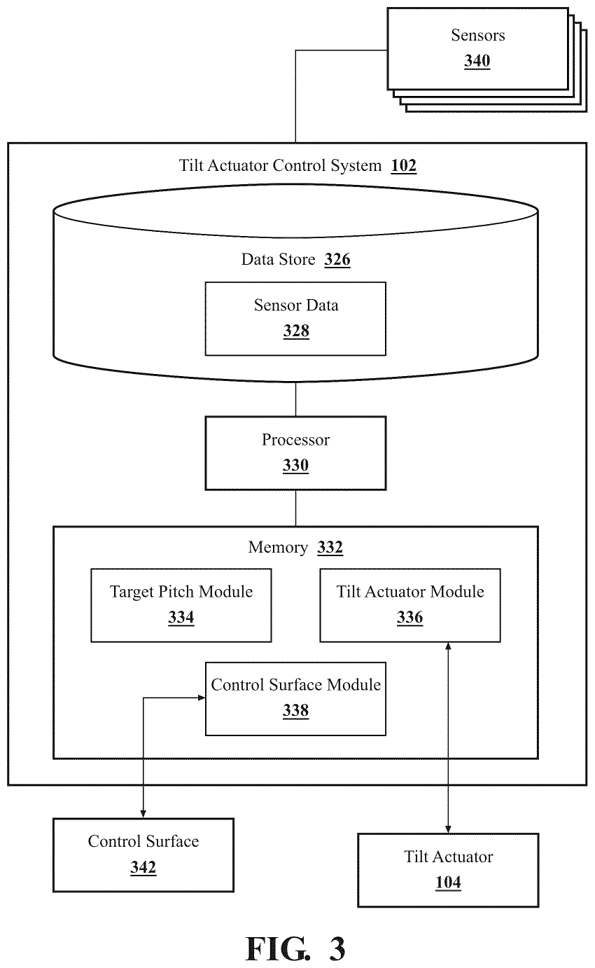

FIG. 3 illustrates one embodiment of a tilt actuator control system 102 that is associated with altering the pitch angle of a wing assembly 106, according to an embodiment of the principles described herein. As depicted in FIG. 3, the tilt actuator control system 102 may include a processor 330. In one or more arrangements, the processor(s) 330 can be a primary/centralized processor of the aircraft 100 or may be representative of many distributed processing units. For instance, the processor(s) 330 can be an electronic control unit (ECU). Alternatively, or additionally, the processors include a central processing unit (CPU), an application-specific integrated circuit (ASIC), a microcontroller, a system on a chip (SoC), and/or other electronic processing units that support operation of the aircraft 100.

In one embodiment, the tilt actuator control system 102 includes a memory 332 that stores a target pitch module 334, a tilt actuator module 336, and a control surface module 338. The memory 332 may be a random-access memory (RAM), read-only memory (ROM), a hard-disk drive, a flash memory, or another suitable memory for storing the modules 334, 336, and 338. The modules 334, 336, and 338 may be, for example, machine-readable instructions that, when executed by the processor 330, cause the processor 330 to perform the various functions disclosed herein. In alternative arrangements, the modules 334, 336, and 338 are independent elements from the memory 332 that are, for example, comprised of hardware elements. Thus, the modules 334, 336, and 338 are alternatively ASICs, hardware-based controllers, a composition of logic gates, or another hardware-based solution.

The aircraft 100 may include one or more data stores 326 for storing one or more types of data. In general, the data store 326 is, in one embodiment, an electronic data structure stored in the memory 332 or another data storage device and that is configured with routines that can be executed by the processor 330 for analyzing stored data, providing stored data, organizing stored data, and so on. Thus, in one embodiment, the data store 326 stores data used by the modules 334, 336, and 338 in executing various functions. The data store 326 can be comprised of volatile and/or non-volatile memory. Examples of memory that may form the data store 326 include RAM, flash memory, ROM, PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drives (SSDs), and/or other non-transitory electronic storage medium. In one configuration, the data store 326 is a component of the processor(s) 330. In general, the data store 326 is operatively connected to the processor(s) 330 for use thereby. The term “operatively connected,” as used throughout this description, can include direct or indirect connections, including connections without direct physical contact.

In one embodiment, the data store 326 stores the sensor data 328 relied on by the modules 334, 336, and 338. That is, the amount of tilt actuation may be based on any number of conditions, such as the current fuselage pitch, the current wing assembly pitch, the current angle of incidence between the wing assembly 106 and the fuselage 108, and an input objective. Accordingly, the sensor data 328 may include data indicative of at least the current fuselage pitch, the current wing assembly pitch, and/or data associated with an input objective.

In an example, the amount of tilt actuation is triggered by and based on the wing assembly pitch. Moreover, tilt actuation may be terminated once the wing assembly 106 reaches a target wing assembly pitch. Accordingly, the aircraft 100 may include sensors 340 that detect the wing assembly pitch. Examples of wing assembly pitch sensors include a gyroscope, an accelerometer, and/or an IMU, among other pitch sensors.

Similarly, the tilt actuation may be triggered by and based on the fuselage pitch. Specifically, tilt actuation may be triggered to place the fuselage 108 at a level pitch. In another example, the angle of incidence between the wing assembly 106 and the fuselage 108 may be determined based on the wing assembly pitch and the fuselage pitch. Accordingly, the aircraft 100 may include sensors 340 that detect the fuselage pitch. Examples of fuselage pitch sensors include an attitude indicator (e.g., an artificial horizon), a gyroscope, an accelerometer, and/or an inertial measurement unit (IMU), among other pitch sensors.

The aircraft 100 may also include an incidence angle sensor, such as an encoder, rheostat, or Hall effect sensor. For example, two sensors (e.g., a wing assembly pitch sensor, a fuselage pitch sensor, or an incidence angle sensor) may be utilized by the tilt actuator control system 102 when making the wing assembly adjustments described herein.

In another example, the target wing assembly pitch is determined by some other input objective, such as a target energy consumption (e.g., reducing fuel consumption) during horizontal flight, a target range (e.g., reducing the drag) during horizontal flight, a target speed during horizontal flight, or a target aerodynamic condition (e.g., maintaining lift at low speeds and reducing lift at high speeds) during horizontal flight, etc. In some cases, the aircraft 100 may include any number of sensors 340 that sense information about the aircraft 100 itself, which information may be used to evaluate compliance with the input objective. For example, where the objective is to reduce fuel consumption, the aircraft 100 may include sensors 340 that measure fuel levels, or fuel usage of the aircraft 100. In another example, where the objective is to reduce battery consumption, the aircraft 100 may include sensors 340 that measure battery levels or electrical consumption of the aircraft 100.

Other examples of sensors 340 that may indicate the state of the aircraft 100 include altitude sensors, air speed sensors, air humidity sensors, and air density sensors, among others. In summary, the aircraft 100 may include any number of sensors 340 that measure different characteristics of the aircraft 100 and/or its flight conditions. The sensor data 328 may include data from these sensors 340. Note that while particular reference is made to particular sensors 340 and particular sensor data 328, the aircraft 100 may include different sensors 340, and the data store 326 may store other sensor data 328, usable by the modules 334, 336, and 338 to guide tilt actuation in a variable incidence wing aircraft towards a target value.

The data store 326 may store the sensor data 328 along with, for example, metadata that characterizes various aspects of the sensor data 328. For example, the metadata can include location coordinates (e.g., longitude and latitude), relative map coordinates or tile identifiers, time/date stamps from when the separate sensor data 328 was generated, and so on.

As described previously, the aircraft 100 can include one or more modules 334, 336, and 338, at least some of which are described herein. In at least one arrangement, the modules 334, 336, and 338 are implemented as non-transitory machine-readable instructions that, when executed by the processor 330, implement one or more of the various functions described herein. In various arrangements, one or more of the modules 334, 336, and 338 are a component of the processor(s) 330, or one or more of the modules 334, 336, and 338 are executed on and/or distributed among other processing systems to which the processor(s) 330 is operatively connected. Alternatively, or in addition, the one or more modules 334, 336, and 338 are implemented, at least partially, within hardware. For example, the one or more modules 334, 336, and 338 may be comprised of a combination of logic gates (e.g., metal-oxide-semiconductor field-effect transistors (MOSFETs)) arranged to achieve the described functions, ASICs, programmable logic arrays (PLA), field-programmable gate arrays (FPGA), and/or other electronic hardware-based implementations to implement the described functions. Further, in one or more arrangements, one or more of the modules 334, 336, and 338 can be distributed among a plurality of the modules 334, 336, and 338 described herein. In one or more arrangements, two or more of the modules 334, 336, and 338 described herein can be combined into a single module.

The tilt actuator control system 102 includes a target pitch module 334. In general, the target pitch module 334 determines the target wing assembly pitch and, in some cases, the target fuselage pitch for the wing assembly 106 and the fuselage 108, respectively.

With regards to the wing assembly pitch, the target pitch module 334 includes instructions that cause the processor 330 to determine, based on an input objective, a target wing assembly pitch for a wing assembly 106 of the aircraft 100, which wing assembly 106 rotates about a pitch axis of the fuselage 108 via action of a tilt actuator 104.

As described, during horizontal flight, a pilot (whether on board or remote) may have various objectives for the flight. For example, a pilot may want to maximize energy consumption during horizontal flight. As another example, a pilot may want to maximize the range of the aircraft 100 during horizontal flight. As yet another, the pilot may want to fly the aircraft at a particular speed during horizontal flight. As yet another example, the pilot may want to fly the aircraft with a particular aerodynamic condition (i.e., a particular lift) during horizontal flight. As described above, it may be that zero incidence between the wing assembly 106 and the fuselage 108 does not allow the aircraft to fly with the target objectives. Accordingly, the present system changes the incidence angle to achieve the target objectives. That is, these different input objectives may be achieved by varying the incidence angle to different degrees.

For example, it may be that a pilot desires to fly the aircraft 100 at a low speed with a level fuselage 108, where the fuselage 108 and wing assembly 106 with matching level pitch angles do not generate sufficient lift to maintain the aircraft 100 altitude. Accordingly, in this example, the tilt actuator control system 102 may increase the wing assembly pitch while the fuselage 108 is level to provide additional lift beyond what would be available were the wing assembly maintained at a level pitch.

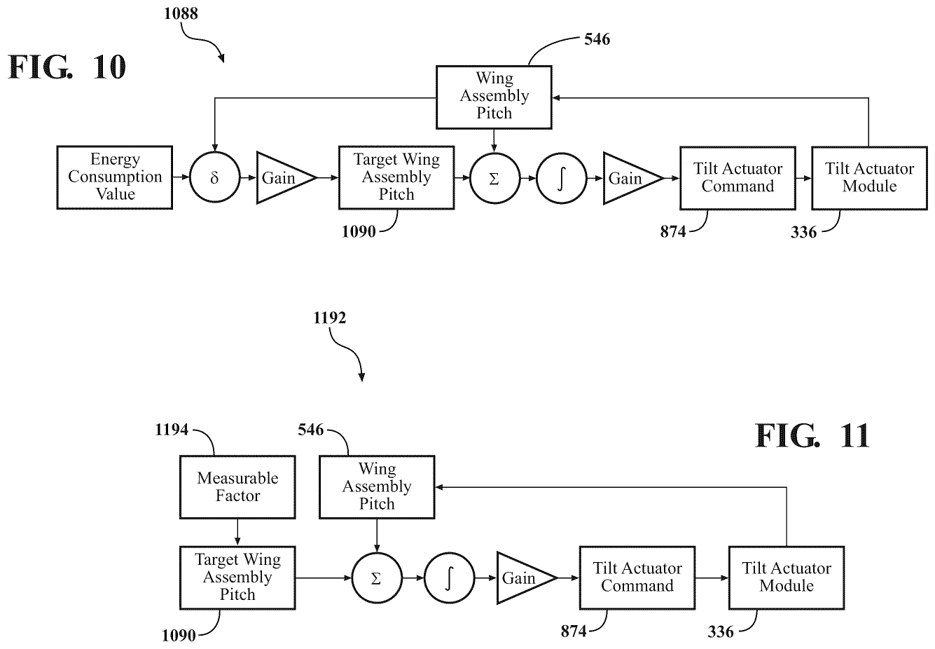

In another example, a pilot may set the aircraft 100 to an economy mode where fuel consumption and/or battery consumption is to be minimized. To achieve the desired fuel economy or battery consumption level, it may be that the wing assembly pitch should be set to a different value than the fuselage pitch. In this example, the target wing assembly pitch may be determined indirectly based on the input objective. That is, the target pitch module 334 may 1) monitor sensor data 328 that indicates fuel economy and 2) determine the target wing assembly pitch based on the sensor data 328. In this example, the target wing assembly pitch may be the wing assembly pitch that results in fuel economy sensor data being maximized and/or fuel usage sensor data being minimized. An example of such a control loop is depicted below in connection with FIG. 10.

In an example, the input objective may be received from a pilot. For example, to fly the aircraft 100 at a slow speed while maintaining the fuselage at a level pitch, the pilot may set the throttle to a predetermined position. If slow enough, the aircraft altitude may drop due to the aircraft 100, with the wing assembly 106 in the generally horizontal position, being unable to provide sufficient lift to maintain altitude. Responsive to this drop in altitude, the target pitch module 334 may, in an closed-loop fashion, indicate that the target wing assembly pitch is some value greater than the current wing assembly pitch and transmit a signal so indicating to the tilt actuator module 336 to alter the activate the tilt actuator 104 to provide additional lift by increasing the pitch angle of the wing assembly 106.

As a different example, due to its camber, the wing assembly 106 may generate a certain amount of lift for a given airspeed. Should the pilot desire to fly the aircraft 100 with greater airspeed, again while keeping the fuselage 108 level, such as for passenger comfort, the wing assembly 106 may generate undesired lift, which may be indicated by an increased altitude. In this example, responsive to the increased altitude, the target pitch module 334 may, in an closed-loop fashion, indicate that the target wing assembly pitch is some value less than the current wing assembly pitch and transmit a signal so indicating to the tilt actuator module 336 to alter the activate the tilt actuator 104 to reduce lift by decreasing the pitch angle of the wing assembly 106.

As yet another example, a pilot may desire to perform an advanced maneuver, such as a steep climb while keeping the fuselage at a reduced pitch attitude or executing a loop maneuver. The pilot initiates this maneuver by pulling back on the control stick. It may be that aircraft 100, with the wing assembly 106 having a zero incidence angle relative to the fuselage 108, may be unable to provide the desired climb. To enable the climb, the tilt actuator control system 102 may increase the pitch angle or incidence angle of the wing assembly 106 to provide additional lift for the climb. In this example, the target pitch module 334 may, in a closed-loop fashion, indicate that the target wing assembly pitch is some value greater than the current wing assembly pitch and transmit a signal so indicating to the tilt actuator module 336 to alter the tilt actuator 104 to increase lift by increasing the pitch angle of the wing assembly 106. Accordingly, in any of these examples, the target pitch module 334 includes instructions that cause the processor 330 to determine the input objective based on manipulation of a flight control input (e.g., the throttle placed to a predetermined position) from a pilot.

In an example, a pilot may be able to select between different modes for the flight, with different modes defining different input objectives. For example, a pilot may select an economy mode, where fuel and/or battery consumption is conserved, thereby maximizing flight endurance. In another example, a pilot may select a range mode, which maximizes the flight range. In another example, a pilot may select a low-speed mode. In any of these examples, the tilt actuator control system 102 includes instructions that cause the processor 330 to identify the input objective based on user selection from a set of candidate objectives. In some examples, a mode and its associated input objective may be selected via an input device on an aircraft controller. For example, in the case of a piloted aircraft, a pilot may select a mode by pressing a button, switching a dial, or using another input on a control panel or control yoke. In the case of a remotely piloted aircraft, a pilot can select a mode using a button, switch, dial, touchpad, or other input on a remote control.

As described in the above examples, it should be noted that the input objective is directed to a target objective during horizontal, cruising, and non-transition flight, with transition flight referring to a period of time wherein an aircraft is actively transitioning from vertical flight to horizontal flight. That is, as opposed to other variable-incidence or tilt-wing aircraft, the present system carries out variable incidence wing functions at times other than landing, taking off, or transitioning between vertical and horizontal flight. Put another way, during horizontal flight, other tilt-wing aircraft may have a substantially slight and fixed incidence angle between a wing assembly and a fuselage. The present system, by comparison, provides a non-zero incidence between the wing assembly 106 and the fuselage 108, which non-zero incidence is dynamic and may be determined based on identified input objectives and flight conditions. Static tilt-wing aircraft incidence may suffer from the same complications presented above, namely reduced lift and efficiency, which the present specification is intended to address by controlling the incidence during horizontal flight to increase the lift and efficiency of the aircraft. That is to say, the target pitch module 334, and the tilt actuator control system 102 in general, provide enhanced control over the variable incidence wing aircraft, thereby enhancing the lift and efficiency of the aircraft 100 during horizontal, cruising, and non-transition flight.

The tilt actuator control system 102 may include a tilt actuator module 336 that includes instructions to 1) measure a wing assembly pitch of the wing assembly 106 and alter an angle of the wing assembly 106 based on a difference between the target wing assembly pitch and the wing assembly pitch. Specifically, the tilt actuator module 336 may extract sensor data 328 indicative of the wing assembly pitch. Given that the tilt actuator module 336 compares a detected wing assembly pitch to the target wing assembly pitch, as determined by the target pitch module 334, the tilt actuator module 336 may be operatively connected to, and receive the output from, the target pitch module 334.

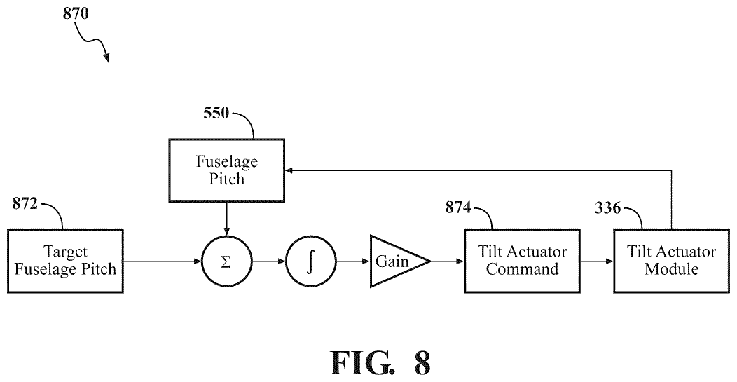

As described above, the target wing assembly pitch may be determined based on a value calculated from an input objective. Accordingly, in this example, the tilt actuator module 336 may compare the measured wing assembly pitch (i.e., the sensor data 328 indicative of fuselage pitch) with an input objective-calculated target pitch (as calculated by the target pitch module 334). The control loops depicted below in connection with FIGS. 8-11, depict example systems that calculate a target pitch based on an input objective.

As described above, the tilt actuator module 336 may cause the processor 330 to adjust the pitch angle of the wing assembly 106 based on the difference between the target wing assembly pitch and the wing assembly pitch as measured by the sensors 340. In other words, the tilt actuator module 336 may generate a signal that instructs a tilt actuator 104 or a controller of the tilt actuator 104 to change position to alter the pitch angle of the wing assembly 106 such that the wing assembly pitch matches the target wing assembly pitch.

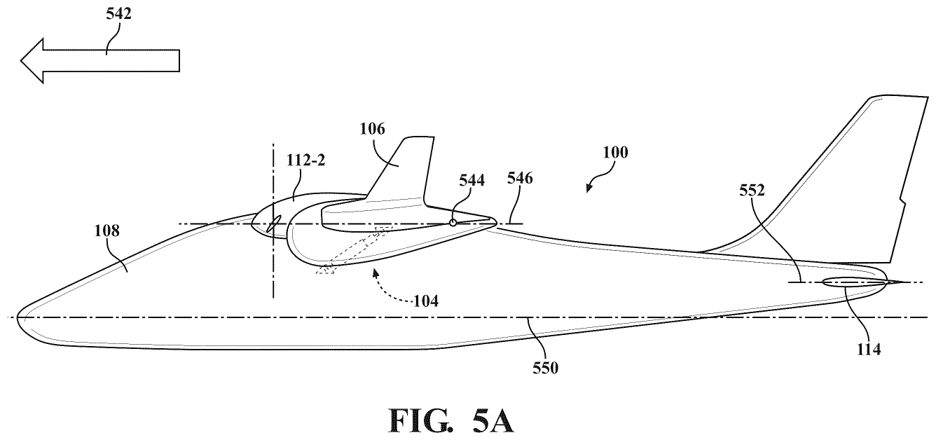

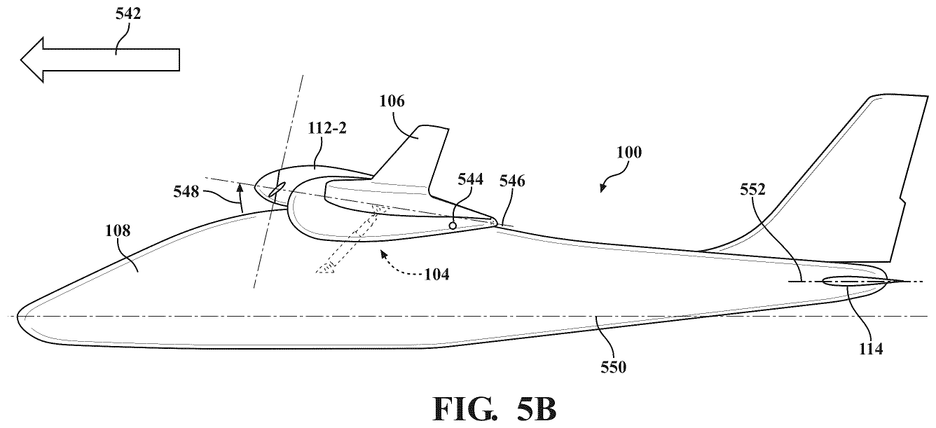

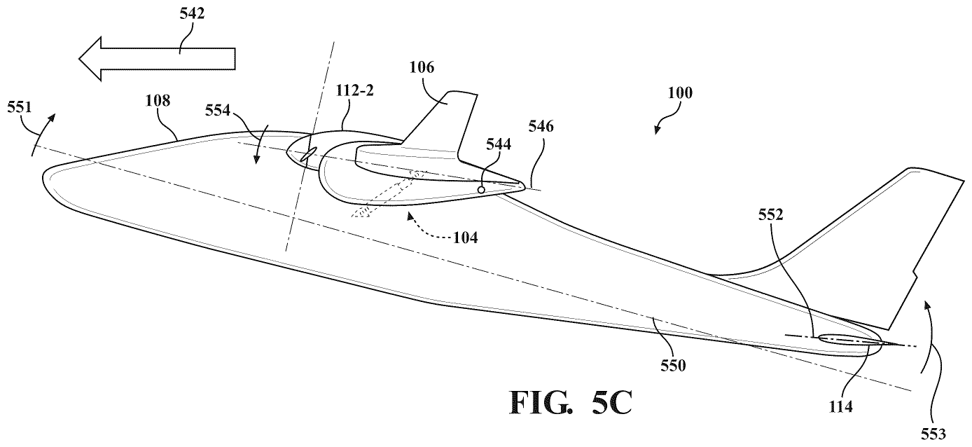

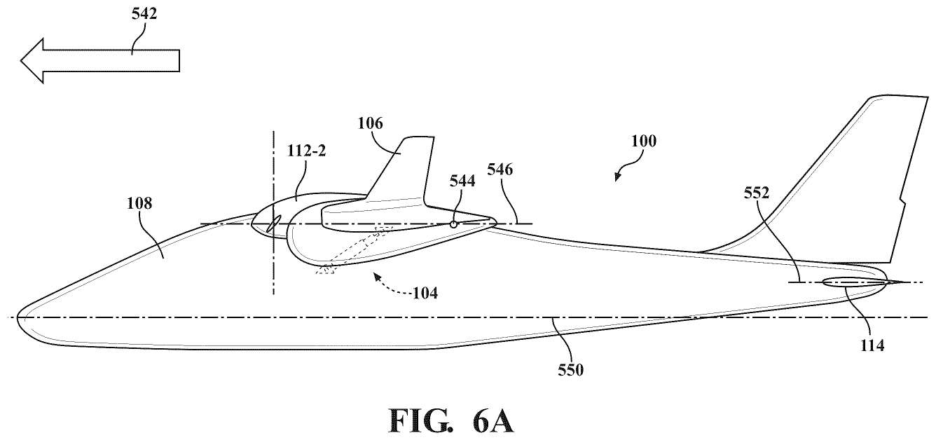

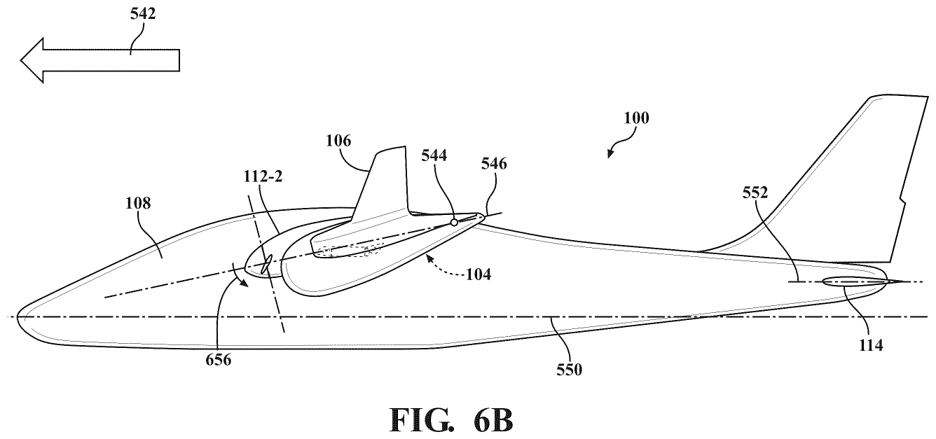

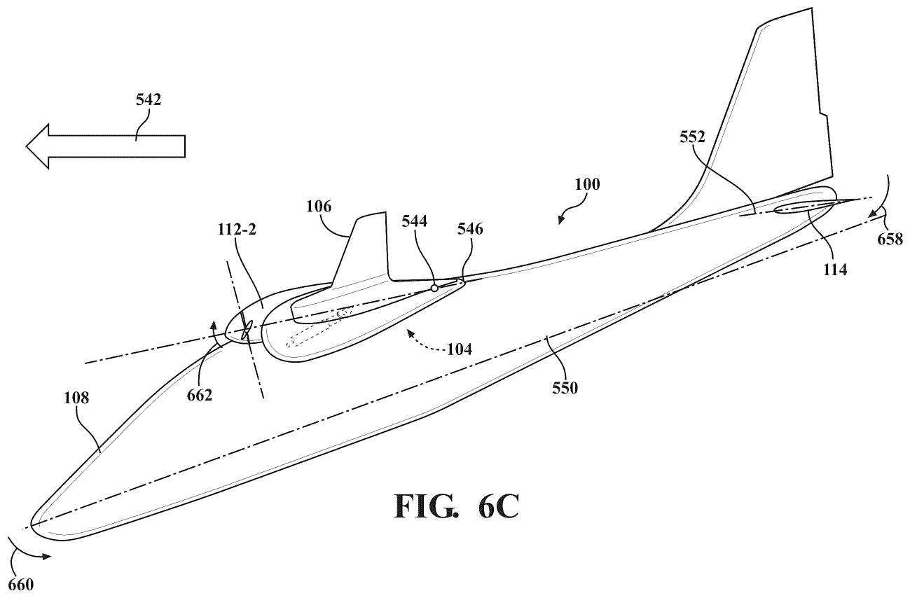

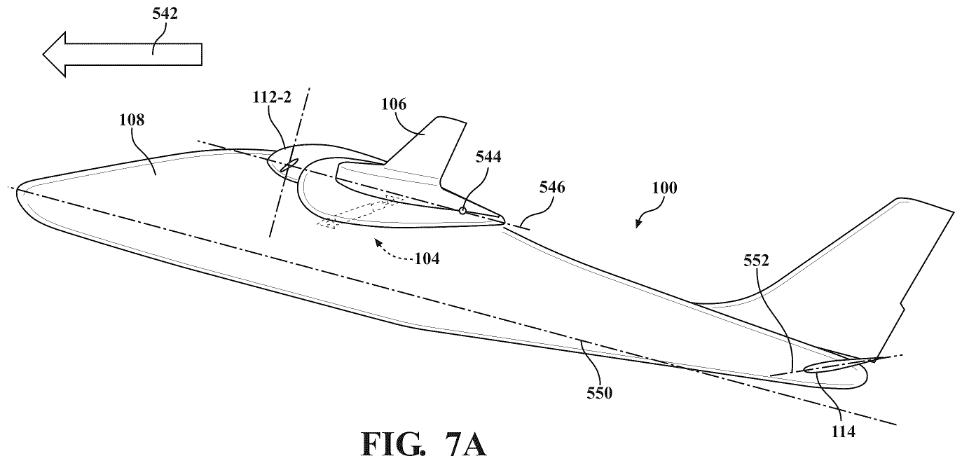

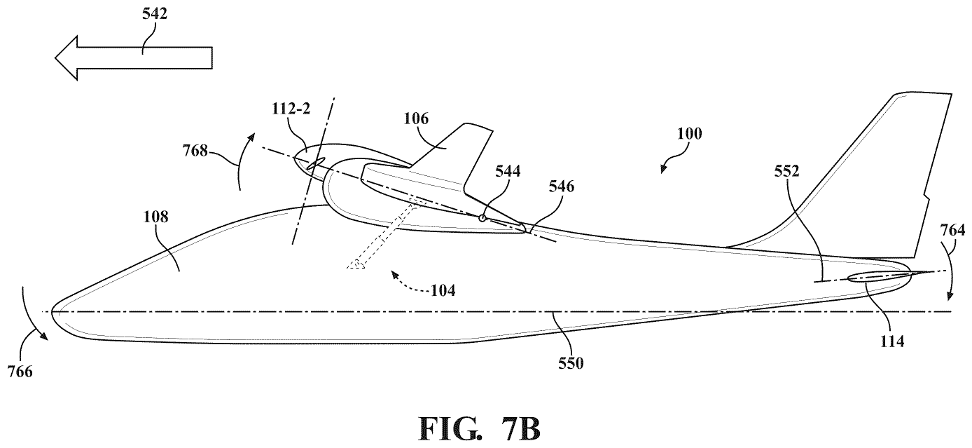

As described above, the alteration may be based on a difference between the wing assembly pitch and some target wing assembly pitch calculated based on an input objective. FIGS. 5A-7B depict various tilt actuations that may be implemented based on a detected difference between a wing assembly pitch and a target wing assembly pitch. For example, as depicted in FIGS. 5A-5C, the tilt actuator module 336 may increase the wing assembly pitch angle to generate more lift for the aircraft 100. As depicted in FIGS. 6A-6C, the tilt actuator module 336 may decrease the wing assembly pitch angle to generate less lift for the aircraft 100. As depicted in FIGS. 7A and 7B, the tilt actuator module 336 may increase the incidence angle between the wing assembly 106 and the fuselage 108 in response to an adjustment of the fuselage pitch via the stabilator 114.

In some examples, in addition to altering the tilt actuator(s) 104, the tilt actuator control system 102 may have the capability of altering the control surfaces 342 (e.g., the stabilator 114) of the aircraft 100. In one example, alteration of the wing assembly pitch may slightly alter the fuselage pitch. That is, while the wing assembly 106 may be able to have a different pitch angle than the fuselage 108, the wing assembly 106 is coupled to the fuselage 108 such that changes to airflow over the wing assembly 106 due to the change in wing assembly pitch may alter the fuselage pitch, albeit slightly. Accordingly, if the pilot desires to keep the fuselage pitch constant, notwithstanding any adjustment to the wing assembly pitch, the tilt actuator control system 102 may include a control surface module 338 that includes instructions to, responsive to an alteration of the pitch angle of the wing assembly 106, cause the processor 330 to alter an angle of a control surface 342 to maintain a fuselage pitch angle.

In another example, the wing assembly pitch change may not be able to provide the desired flight characteristic desired by the pilot. For example, a wing assembly 106 may have an upper limit on how much it can pitch before a wing stall occurs. That is, if the wing assembly 106 is pitched to too great a degree relative to the direction of airflow, the airflow may pull away from the contours of the wings 110-1 and 110-2, thus reducing the lift generated by the wings 110-1 and 110-2. This may cap the lift that the wing assembly 106 can generate. However, a pilot may desire more overall lift of the aircraft 100 than can be provided by the wing assembly 106 without resulting in a wing stall.

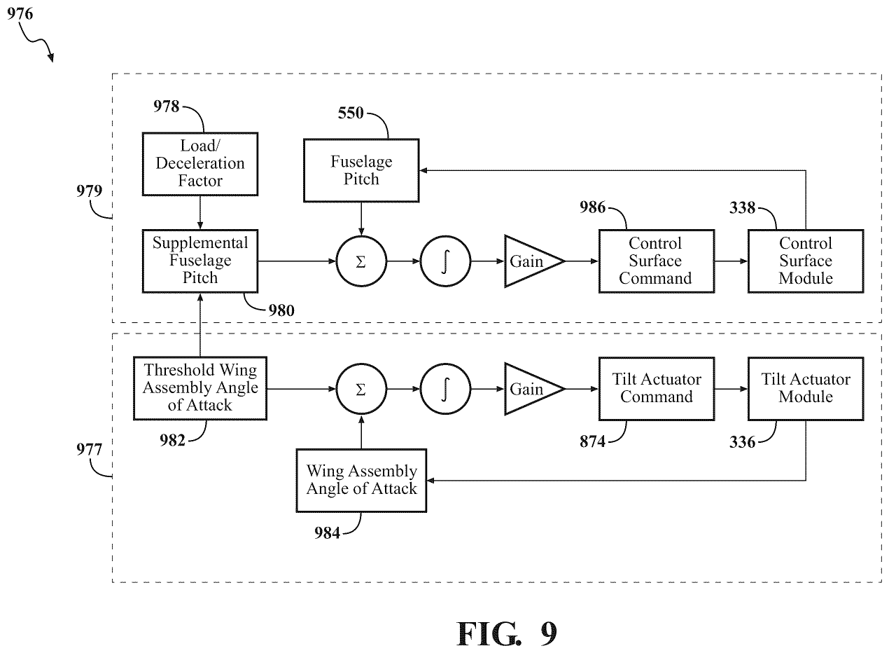

The fuselage 108, by comparison, may be able to sustain much higher angles of attack before loss of lift. Accordingly, if the pilot desires a greater lift than can be provided by the wing assembly without resulting in a wing stall, the stabilator 114, or other control surface, may be deflected such that the fuselage pitch is increased, thus generating the additional desired lift. Providing the additional lift via fuselage pitch increase may increase the drag on the aircraft 100, which may be acceptable given the desired flight environment. A pilot may desire this non-parallel, positively pitched configuration of the wing assembly and the fuselage when flying the aircraft 100 at low speeds or high bank angles. An example of a control loop for this scenario is depicted in FIGS. 9 and 11 below.

As the fuselage 108 pitch may not contribute to a stall state, the fuselage 108 may be pitched higher than the wing assembly 106 to increase lift, without increasing the risk of wing stall. Accordingly, in this example, when the pilot desires more lift and the wing assembly 106 is at its operational threshold (i.e., the wing assembly 106 has a particular angle of attack over which a wing stall occurs), the control surface module 338 may alter a fuselage control surface angle to provide the additional lift. In this example, the tilt actuator module 336 may include instructions that cause the processor 330 to detect that the wing assembly 106 has reached its operational threshold. As described above, this may be based on the output of an angle-of-attack sensor.

The target pitch module 334 may determine, based on the input objective, a target fuselage pitch for the fuselage 108. As described above, the input objective may be based on the manipulation of an input from a pilot. For example, in the case where the pilot intends to fly the aircraft 100 at a slow speed, the pilot may set the throttle to a predetermined position. As described above, responsive to a drop in altitude that may result, the target pitch module 334 may, in an closed-loop fashion, indicate that the target wing assembly pitch is some value greater than the current wing assembly pitch and transmit a signal so indicating to the tilt actuator module 336 to alter the activate the tilt actuator 104 to provide additional lift by increasing the pitch angle of the wing assembly 106. However, if the tilt actuator 104 increases the wing assembly pitch to an operational threshold and the desired airspeed has not been reached and/or the aircraft continues to lose altitude, the target pitch module 334 may, in a closed-loop fashion, indicate that the fuselage pitch may be adjusted to achieve the desired airspeed or lift, where the target fuselage pitch is greater than the current fuselage pitch. In this example, the target pitch module 334 may transmit a control signal to the control surface module 338 to deflect the control surface 342 to increase the fuselage pitch to provide additional lift.

In any case, with the target fuselage pitch calculated, the control surface module 338 may measure a fuselage pitch of the fuselage 108 (via the sensor data 328) and alter a fuselage control surface 342 angle based on a difference between the target fuselage pitch and the fuselage pitch. As described above, the detection of the difference may occur in a closed-loop fashion, where the fuselage pitch is adjusted until the desired airspeed and/or altitude are achieved.

As described above, alteration of the fuselage pitch may also adjust the wing assembly pitch. Accordingly, changing the aircraft control surface 342 will cause the entire aircraft (including the wing assembly 106) to pitch. This movement may cause the wing assembly to move outside its operational range, resulting in a wing stall. Accordingly, in this example, the tilt actuator module 336 may alter the angle of the wing assembly 106 to maintain the wing assembly 106 within its operational threshold.

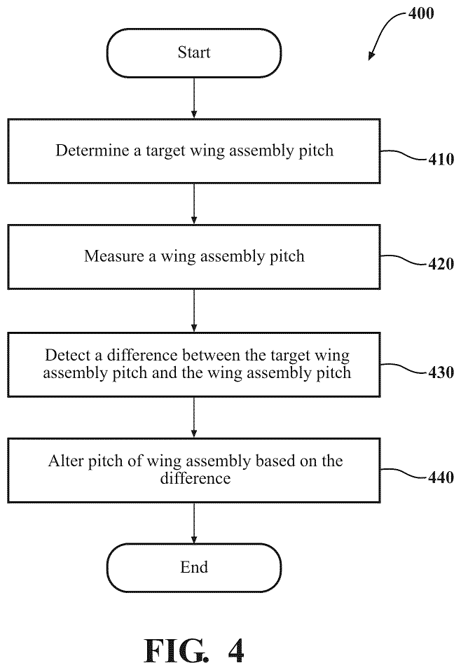

Additional aspects of changing the wing assembly pitch in a variable incidence wing aircraft will be discussed in relation to FIG. 4. Method 400 will be discussed from the perspective of the tilt actuator control system 102 of FIGS. 1 and 3. While method 400 is discussed in combination with the tilt actuator control system 102, it should be appreciated that the method 400 is not limited to being implemented within the tilt actuator control system 102 but is instead one example of a system that may implement the method 400.

At 410, the target pitch module 334 determines a target wing assembly pitch for the wing assembly 106 of the aircraft 100, where a wing assembly 106 of the aircraft 100 rotates about a pitch axis of the fuselage 108 via action of a tilt actuator 104. As described above, the target wing assembly pitch may be a pitch calculated based on the input objective, which determines the desired characteristics of the flight (e.g., reduced fuel consumption, reduced drag, low-speed flight, etc.).

In general, the tilt actuator module 336 determines a difference between the wing assembly pitch and the target wing assembly pitch calculated by the target pitch module 334. Accordingly, at 420, the tilt actuator module 336 measures the wing assembly pitch by extracting sensor data 328 indicative of the wing assembly pitch. At 430, the tilt actuator module 336 determines the difference between this measured value and the target value, whatever that target value may be.

At 440, the tilt actuator module 336 generates a control signal based on the detected difference to alter the pitch angle of the wing assembly 106 accordingly. In some examples, such an adjustment may be based on the real-time data, i.e., the real-time detected difference, in which case the adjustment may terminate when the measured wing assembly pitch matches the target wing assembly pitch.

In an example, the tilt actuator control system 102 controls the sensors 340 to acquire the sensor data 328 at successive iterations or time steps. Thus, the tilt actuator control system 102, in one embodiment, iteratively executes the functions discussed at blocks 410-440 to acquire the sensor data 328 and provide information therefrom.

FIGS. 5A-5C are side views of an aircraft 100 with wing assembly 106 pitch adjustments to increase lift, according to an embodiment of the principles described herein. Specifically, FIGS. 5A-5C depict the fuselage 108 with the wing assembly 106 and wing-mounted propellers 112-1 (not shown) and 112-2 and the stabilator 114. As described above, while FIGS. 5A-5C and others depict specific thruster sources (e.g., propellers) and control surfaces 342 (e.g., stabilator 114), the principles described herein may apply equally to other control surfaces 342 and thruster types.

FIGS. 5A-5C also depict the pitch angles of the relative components. For example, the fuselage pitch 550, the wing assembly pitch 546, and the stabilator pitch 552. In the example depicted in FIGS. 5A-5C, the aircraft 100 is flying in a direction 542, and all the pitches 550, 546, and 552 are aligned with one another and generally aligned with the flight direction 542. This may result in an optimal lift and efficiency in some conditions. However, as depicted in the examples below, it may be that the target condition departs from the depicted arrangement. Accordingly, the tilt actuator control system 102 of the present specification is intended to alter the wing assembly pitch 546 to achieve some target arrangement. FIG. 5A also depicts the pivot point 544 around which the wing assembly 106 rotates in the pitch axis.

FIGS. 5A and 5B are side views of the aircraft 100 with the wing assembly 106 and stabilator 114 adjusted to increase lift in the aircraft 100. These adjustments may be triggered when a pilot desires to fly the aircraft 100 at a low speed while maintaining the fuselage level for some reason (for example, for passenger comfort), where the wing assembly 106 and fuselage 108 cannot generate sufficient lift to maintain altitude. That is, the input objective may be a target airspeed for the aircraft 100 during horizontal flight. As described above, the input objective may be determined as the pilot sets the throttle to a predetermined position. Also, as described above, the sensors 340 of the aircraft 100 may, responsive to the aircraft 100 slowing down, indicate that the aircraft 100 is undesirably losing altitude. This may indicate that additional lift is needed to maintain altitude when flying at a slow speed. Accordingly, the tilt actuator control system 102 may activate the tilt actuator 104 to raise the wing assembly 106 as depicted by arrow 548 in FIG. 5B to increase the angle of attack necessary to maintain altitude, while keeping the fuselage 108 level. That is, the tilt actuator control system 102 may include instructions that cause the processor 330 to alter the pitch angle of the wing assembly 106 so the wing assembly is more positively pitched than the fuselage.

In some examples, the target pitch may be determined in a closed-loop fashion, where the target pitch module 334 determines that a greater pitch is needed to achieve the target lift. Note that, notwithstanding the wing assembly pitch 546 and the thrust direction, the aircraft 100 may still have the same flight direction 542. That is, when flying at lower speeds, a thrust source may need a greater pitch angle to maintain altitude.

As described above, in some examples, even more lift may be desired. However, as the wing assembly 106 has an operational threshold (e.g., a maximum angle of attack past which the wing may stall), further increasing the wing assembly pitch 546 may not be desirable. However, as described above, additional lift may still be provided by increasing the fuselage pitch 550. Accordingly, responsive to 1) an indication that additional lift is desired and 2) an indication that the wing assembly 106 has reached its operational threshold (i.e., via the output of an angle of attack sensor), the target pitch module 334 may indicate that the fuselage pitch 550 may be raised to provide the additional lift. Note that examples of a communicated demand for additional lift may come from various pilot controls, such as a pull-up, high-bank turn, or steady-level flight near stall speed.

As with determining the target wing assembly pitch, the target fuselage pitch may be determined in a closed-loop fashion, where the target pitch module 334 determines that a greater fuselage pitch is needed to achieve the target lift. Responsive to this determination, the control surface module 338 may deflect the tail of the stabilator 114 up as indicated by the arrow 553 in FIG. 5C. A downward force is generated on the stabilator 114 and rear of the fuselage 108, which pitches the aircraft nose (including the wing assembly 106) upward as indicated by the arrow 551, thus generating the additional lift.

However, as the movement of the stabilator 114 pitches the entire aircraft 100, the wing assembly may be further pitched, in some cases past its operational threshold. Accordingly, in this example, responsive to 1) an indication that the wing assembly 106 has reached its operational threshold (i.e., via the output of an angle of attack sensor) and 2) an indication that the fuselage pitch 550 is changing, the tilt actuator module 336 may activate the tilt actuator 104 to pitch the wing assembly 106 down as indicated by the arrow 554 in FIG. 5C to maintain the wing assembly within its operational threshold. In an example, the control of the tilt actuator 104 and the control surface 342 may occur until the wing assembly pitch 546 matches the target wing assembly pitch, at which point the tilt actuator control system 102 may terminate control surface adjustments. In this example, that point in time may be determined when the desired airspeed is achieved and/or the aircraft 100 is maintaining altitude.

Thus, the present system facilitates flying a variable incidence wing aircraft 100 at a low speed by dynamically altering the wing assembly pitch 546 and the fuselage pitch 550 based on the input objective, which is identified based on pilot manipulation of flight controls and sensor data 328. Note that for purposes of illustration, in FIGS. 5A-7B, the altered position of the wing assembly 106, fuselage 108, and stabilator 114 may be exaggerated to more clearly depict the principles discussed herein.

FIGS. 6A-6C are side views of an aircraft 100 with wing assembly 106 pitch adjustments to decrease lift, according to an embodiment of the principles described herein. As described above, in some examples, the aircraft configuration depicted in FIG. 6A may result in less-than-ideal operating conditions. For example, some wings have a positive camber, which may produce positive lift when the aircraft 100 has zero angle of attack at a predetermined air speed. If the aircraft 100 were to fly at a speed greater than the predetermined air speed, additional lift may be generated, which may cause the aircraft 100 to rise (and therefore not maintain a desired altitude) due to the additional lift generated by the positively cambered wing assembly. While the fuselage pitch 550 and wing assembly pitch 546 could both be lowered to counter the camber-induced lift, angling the fuselage 108 down may be undesirable for a variety of reasons, including passenger comfort, load stability, efficiency, etc. Accordingly, the tilt actuator control system 102 of the present specification is intended to alter the wing assembly pitch 546 to achieve some target wing assembly pitch while keeping the fuselage 108 level or at a more gentle pitch.

FIGS. 6B and 6C are side views of the aircraft 100 with the wing assembly 106 and stabilator 114 adjusted to reduce lift in the aircraft 100, while maintaining the fuselage 108 level for some particular reason. These adjustments may be triggered when a pilot desires to fly the aircraft 100 at a high speed, where the wing assembly 106 and fuselage 108 generate too much lift, causing the aircraft 100 to rise. In this example, the input objective may be a target airspeed for the aircraft 100 during horizontal flight and maintaining the fuselage 108 level. As described above, the input objective may be determined as the pilot sets the throttle to a predetermined position. Also, as described above, the sensors 340 of the aircraft 100 may indicate that the aircraft 100 is undesirably gaining altitude. This may indicate that the lift generated by the aircraft 100 should be reduced. Accordingly, the tilt actuator control system 102 may activate the tilt actuator 104 to reduce the wing assembly pitch 546 as depicted by arrow 656 in FIG. 6B to decrease the angle of attack to maintain altitude. That is, the tilt actuator control system 102 may include instructions that cause the processor 330 to alter the pitch angle of the wing assembly 106 so the wing assembly 106 is more negatively pitched than the fuselage 108.

In some examples, the target pitch may be determined in a closed-loop fashion where the target pitch module 334 determines that less pitch is needed to achieve the target lift. Note that, notwithstanding the wing assembly pitch 546 and the thrust direction, the aircraft 100 may still have the same flight direction 542. That is, when flying at higher speeds, a thrust source may need a reduced pitch angle to maintain altitude.

As described above, in some examples, even less lift may be desired. However, a wing stall may occur if the wing assembly 106 is negatively pitched too much. Accordingly, the tilt actuator control system 102 may deflect the trailing edge of the stabilator 114 downward, which further pitches the fuselage 108 downward, thus providing additional negative lift. Accordingly, responsive to 1) an indication that reduced lift is desired and 2) an indication that the wing assembly 106 has reached its operational threshold (i.e., via the output of an angle of attack sensor), the target pitch module 334 may indicate that the fuselage pitch 550 may be lowered to provide the reduced lift. As with determining the target wing assembly pitch, the target fuselage pitch can be determined in a closed-loop fashion, where the target pitch module 334 determines that a reduced fuselage pitch 550 is desired to achieve the target lift. Responsive to this determination, the control surface module 338 may deflect the tail of the stabilator 114 down as indicated by the arrow 658 in FIG. 6C. An upward force is generated on the stabilator 114 and rear of the fuselage 108, which pitches the aircraft nose (including the wing assembly 106) downward as indicated by the arrow 660 in FIG. 6C, thus further reducing the generated lift.

However, as the movement of the stabilator 114 pitches the entire aircraft 100, the wing assembly 106 may be further pitched, in some cases past its operational threshold. Accordingly, in this example, responsive to 1) an indication that the wing assembly 106 has reached its operational threshold (i.e., via the output of an angle of attack sensor) and 2) an indication that the fuselage pitch 550 is changing, the tilt actuator module 336 may activate the tilt actuator 104 to pitch the wing assembly 106 up as indicated by the arrow 662 in FIG. 6C to maintain the wing assembly 106 in its operational range. In an example, the control of the tilt actuator 104 and the control surface 342 may occur until the wing assembly pitch 546 matches the target wing assembly pitch, at which point the tilt actuator control system 102 may terminate control surface adjustments. In this example, that point in time may be determined when the desired airspeed is achieved and/or the aircraft 100 is maintaining altitude.

Pitching the fuselage 108 up or down as depicted in FIGS. 5B, 5C, 6B, and 6C may allow the aircraft 100 to decelerate more quickly. That is, as described above, the misalignment of the wing assembly pitch 546 and the fuselage pitch 550 may increase drag. Accordingly, the fuselage 108 may act as an airbrake to slow the aircraft 100 down more quickly than would otherwise be possible. In this example, the pilot may enable the misaligned fuselage and wing assembly pitches and/or define an allowed difference by selecting a mode of the aircraft 100 that facilitates advanced maneuvers (i.e., rapid deceleration). In another example, the pilot may select a desired level of negative lift or a desired altitude, and the tilt actuator control system 102 may automatically adjust the target fuselage pitch when the desired level of negative lift or altitude is not maintained solely by movement of the wing assembly.

Thus, the present system facilitates flying a variable incidence wing aircraft 100 at a wider range of speeds and loadings by dynamically altering the wing assembly pitch 546 and the fuselage pitch 550 based on the input objective, which is identified based on pilot manipulation of flight controls and sensor data 328.

Note that the intent to have the wing assembly and fuselage 108 pitched to different degrees may be based on the input objective, which may be determined via pilot selection. For example, a pilot may select a particular “mode” of an aircraft 100, such as an aerobatic mode, where more advanced maneuvers (i.e., greater lift and greater speed) are permitted and the wing assembly 106 and/or fuselage 108 are pitched to facilitate those advanced maneuvers. As another example, the pilot may select a desired level of lift, and the tilt actuator control system 102 may automatically adjust the target fuselage pitch when the desired level of lift is not achieved solely through movement of the wing assembly.

FIGS. 7A-7B are side views of an aircraft 100 with fuselage 108 pitch adjustments while the wing assembly 106 is maintained in a pitched-up orientation, according to an embodiment of the principles described herein. As described above, to maintain altitude, an aircraft 100 (i.e., both the fuselage 108 and the wing assembly 106) may be pitched up. However, this may give rise to various undesirable circumstances. For example, a pilot in the cabin of the aircraft 100 may lose visibility of the ground, which may be particularly problematic in certain low-speed maneuvers such as landing. As another example, the payload of the aircraft 100 may necessitate a level deck angle for the fuselage 108. As a specific example, the aircraft 100 payload may include sensors whose operation relies on a level surface. In either of these conditions, a fixed-wing aircraft in the configuration depicted in FIG. 7A may lead to non-ideal and, in some cases, dangerous operating conditions.

Accordingly, in these and other situations, the control surface module 338 may deflect the tail end of the control surface 342 (e.g., the stabilator 114) down as indicated by the arrow 764 as depicted in FIG. 7B. An upward force is generated on the stabilator 114 and rear of the fuselage 108, which pitches the aircraft nose (including the wing assembly 106) downward as indicated by the arrow 766 in FIG. 7B, thus setting the fuselage 108 to have a level flight deck. In this example, to maintain lift, the tilt actuator module 336 may activate the tilt actuator 104 to raise the wing assembly pitch, as indicated by the arrow 768 in FIG. 7B, thus still providing the desired lift, even at slow speeds, while maintaining a level flight deck, which may be desirable in some circumstances. Note that in both FIGS. 7A and 7B, the wing assembly pitch 546 is positive, although the wing assembly pitch 546 has a slightly higher angle of attack in FIG. 7B as the fuselage 108 produces less lift.

Note that in any of the examples depicted in FIGS. 5A-7B, the adjustments may be dynamic and based on actual sensor data 328. That is, rather than the aircraft 100 relying on static and predetermined incidences between the wing assembly 106 and the fuselage 108, the present system provides customizable, real-time, and dynamic changes. This may accommodate the changing conditions of a flight. For example, a static and pre-determined landing incidence between the longitudinal axis of the wing assembly 106 and the fuselage 108 may be based on an aircraft returning from a mission with an empty payload, and thus lighter in weight. However, flight dynamics may be different in the event, for example, that the aircraft 100 returns from the flight fully loaded, due to an incident in the air or unexpectedly taking on cargo at the destination. In such cases, a static and predetermined landing incidence may be incorrect. The present system addresses this by comparison, being dynamic and closed-loop based on sensor feedback.

In the examples described herein, the tilt actuator control system 102 may determine the target wing assembly pitch in real-time by monitoring sensor data 328 indicative of a particular condition and altering the wing assembly pitch 546 until the sensor data 328 aligns with the objective. In other words, the target wing assembly pitch may be determined in real-time by processing the sensor data 328 to find when a metric associated with the input objective is minimized or when the input objective is achieved. For example, the aircraft 100 may include fuel sensors that measure aircraft 100 fuel levels and/or consumption and that indirectly indicate the drag on the aircraft 100. That is, greater fuel consumption rates correlate to increased drag. Accordingly, the aircraft 100 may monitor fuel consumption and identify the optimized drag state where the least fuel is consumed. Specifically, the tilt actuator control system 102 may monitor fuel consumption and continually adjust the wing assembly pitch 546 until the fuel consumption or fuel usage rate is minimized. This example illustrates the use of a minimum value for a metric to determine the target wing assembly pitch. Accordingly, the tilt actuator control system 102 may set the target fuselage pitch as the pitch that results in minimized fuel consumption. An example of a control loop for this scenario is depicted in FIG. 10 below.

In an example where a target lift mode is selected (i.e., a target aerodynamic condition), the tilt actuator control system 102 may calculate a lift of the aircraft by monitoring such sensors as an angle of attack sensor, a pitot tube, a static port, a vertical accelerometer, a strain gauge, or flight data computers and processing this sensor data. In this example, the tilt actuator control system 102 may adjust the wing assembly pitch 546 until the calculated lift matches the target lift value indicated by the pilot. This is an example of relying on the input objective to determine the target fuselage pitch.

Accordingly, in both these examples, rather than setting the wing assembly pitch to a target value, the tilt actuator control system 102 may define the target wing assembly pitch by some additional sensor data 328 value. Note that this target wing assembly pitch may adjust as flight conditions change. In these examples, the tilt actuator control system 102 may monitor, based on the input objective, a metric associated with the input objective and select the target wing assembly pitch that results in the metric being at least one of a maximum value, a minimum value, or another predetermined value. That is, the tilt actuator control system 102 may alter the angle of the wing assembly until the metric is minimized, maximized, or met. The tilt actuator control system 102 may then set the pitch which results in the metric being minimized, maximized, or met as the target wing assembly pitch.

FIG. 8 depicts a control loop 870 that adjusts the wing assembly pitch 546 based on a target fuselage pitch, according to an embodiment of the principles described herein. As described above, for a variable incidence wing aircraft 100, the wing assembly pitch 546 may differ from the fuselage pitch 550, which may be desirable in some circumstances. For example, as depicted in FIG. 7B, it may be desirable to maintain a level flight deck for the fuselage 108 at low speeds by raising the wing assembly pitch 546, which may not be possible for fixed-wing aircraft. For example, in some situations, it may be desirable to align the fuselage pitch 550 with a target fuselage pitch 872, which, in one example, may be a level pitch, such as that indicated by an artificial horizon, regardless of the wing assembly pitch 546. This may provide low-drag flight conditions, help maintain certain fuselage-mounted sensors at a level position, or enhance pilot visibility.

Accordingly, per the example control loop 870 depicted in FIG. 8, the tilt actuator control system 102 may alter the wing assembly pitch 546 to align the fuselage pitch 550 to the predetermined pitch. That is, the target fuselage pitch may be a fixed value, and the tilt actuator control system 102 may include instructions that alter the angle of the wing assembly 106 so that the fuselage pitch 550 matches the fixed value.

As described above, the aircraft 100 may include sensors 340 that sense the actual, or measured, pitch of the wing assembly 106 and of the fuselage 108. In this example, the target pitch module 334 sums (e.g., “Σ”) measured values of the fuselage pitch 550 and the target fuselage pitch 872. The summation indicates a difference between the two.

In the example depicted in FIG. 8, the control loop 870 prescribes a smoothing function. For example, the difference between a fuselage pitch 550 and the target fuselage pitch 872 may be attributable to the tilt actuator module 336 responding, albeit lagging, to a detected difference. Accordingly, rather than activating the tilt actuator 104 when the difference is greater than a predetermined amount, which may result in superfluous adjustments and/or jerky flight control, the tilt actuator module 336 may activate the tilt actuator 104 when the difference is greater than a predetermined amount for a predetermined time. In the example depicted in FIG. 8, a time-dependent summation is calculated by integrating (e.g., ∫) the summation of the difference between the fuselage pitch 550 and the target fuselage pitch 872. That is, the tilt actuator module 336 may include instructions that cause the processor 330 to detect a time-dependent difference between the fuselage pitch 550 and the target fuselage pitch 872. This smoothing out may eliminate steady-state angular error and may be less prone to oscillation than a proportional control. Note that while FIG. 8, and others, depict integration as one mechanism for generating a time-dependent difference; other smoothing mechanisms may be employed, such as ramps, filters, IIR filters, delays, proportional filters, linear-quadratic regulators (LQRs), model predictive control (MPC), extended Kálmán filters (EKF), artificial neural networks (ANN), or any other controller.

In some examples, the integrated difference is subjected to processing, filtering, or other conditioning (e.g., “gain”) to enhance the difference signal. The difference signal may be converted into a tilt actuator command 874, which is a command signal for the tilt actuator 104 to operate in a manner that places the wing assembly 106 at a position to set the fuselage pitch 550 to match the target fuselage pitch 872. That is, to activate the tilt actuator 104, the tilt actuator module 336 actuates a variety of actuators, servos, and potentiometers. The tilt actuator command 874 generates electrical signals for each of these components to operate in a way that physically moves the tilt actuator 104 to achieve a desired pitch change in the wing assembly 106.

The size of the difference may define the tilt actuator command 874. For example, when the fuselage pitch 550 matches the target fuselage pitch 872, no tilt actuator command 874 may be generated. As the difference between the two increases, the tilt actuator command 874 may be adjusted to match the degree of difference. Thus, the tilt actuator control system 102 is not a static and passive implementation of a predetermined incidence between the wing assembly 106 and the fuselage 108, but rather an active and dynamic closed-loop correction based on real-time sensor data 328.

FIG. 9 depicts a control loop 976 that adjusts the fuselage pitch and wing assembly pitch based on a target load factor (e.g., lift), according to an embodiment of the principles described herein. FIG. 9 may be an example of a control loop implemented to carry out the maneuvers depicted in FIGS. 5A-6C. As described above, in some cases, the adjustment to the wing assembly pitch 546 may cause the wing angle of attack 984 to approach the threshold wing assembly angle of attack 982, which threshold, if surpassed, may lead to a wing stall. Accordingly, in this case, a supplemental fuselage pitch 980 may be determined. Adjusting the control surface 342 may result in additional fuselage pitch 550 that achieves the desired load/deceleration factor 978. Note that the lower control sub-loop depicted in FIG. 9, which provides supplemental fuselage pitch adjustments if the wing angle of attack 984 approaches the threshold wing assembly angle of attack 982, may be implemented in the control loops depicted in FIGS. 8, 10, and 11.

In the example depicted in FIG. 9, it may be desirable to pitch the fuselage 108 in addition to pitching the wing assembly 106, each to different values. As described above, this misaligned pitch configuration may provide increased positive or negative lift (referred to as load factor or vertical Gs) above what a wing assembly adjustment alone can provide, and may also provide extra deceleration due to drag. Accordingly, a user may set a desired load/deceleration factor 978 (for example, by adjusting aircraft throttle, control stick positions, etc.), and the tilt actuator control system 102 may determine how the wing assembly 106 should be pitched to provide the desired load or if increasing the fuselage pitch 550 would increase the drag to accommodate the desired deceleration rate. Either of these selections could be mapped to a supplemental fuselage pitch 980 value.

As described above, should the wing assembly angle of attack 984 approach the threshold wing assembly angle of attack 982, the wing may be unable to achieve the desired load/deceleration factor 978. Accordingly, in this example, the tilt actuator control system 102 may receive as input the output of a wing angle-of-attack sensor. In this example, the target pitch module 334 sums (e.g., “Σ”) measured values of the wing assembly angle of attack 984 and the threshold wing assembly angle of attack 982. The summation indicates a difference between the two.

In the example depicted in FIG. 9, the lower sub-loop 977 prescribes a time-dependent summation to prevent superfluous adjustments and/or jerky flight control. In some examples, the integrated difference is subjected to processing, filtering, or other conditioning (e.g., “gain”) to enhance the difference signal. The difference signal may be converted into a tilt actuator command 874, which is a command signal for the tilt actuator 104 to operate in a manner that places the wing assembly 106 at a position to achieve the desired load (e.g., lift) or deceleration factor 978.

However, if the wing assembly angle of attack 984 is at or near its threshold angle and the load/deceleration factor 978 exceeds what the wing assembly 106 can provide, then the upper sub-loop 979 is triggered to increase the fuselage pitch 550 angle to supplement the lift produced by the entire aircraft 100. This is represented by both the threshold wing assembly angle of attack 982 and the load/deceleration factor 978 being input into the supplemental fuselage pitch calculation.

The control surface module 338 may sum (e.g., “Σ”) the fuselage pitch 550 and the supplemental fuselage pitch 980, which may be defined by the aircraft load/deceleration factor 978.

In the example depicted in FIG. 9, the upper sub-loop 979 prescribes a smoothing function to prevent superfluous adjustments and/or jerky flight control. This smoothing out may eliminate steady-state angular error and may be less prone to oscillation than a proportional control.

In some examples, the integrated difference is subjected to processing, filtering, or other conditioning (e.g., “gain”) to enhance the difference signal. The smoothed difference signal may be converted into the control surface command 986 and transmitted to the control surface module 338.

As in the above case, the control surface command 986 may be defined by the size of the difference. As the difference between the values increases, the control surface command 986 may be adjusted to match the degree of difference. Note that, as described previously, the control surface command 986 may be executed simultaneously with the tilt actuator command 874 to maintain the wing assembly angle of attack 984 below the threshold wing assembly angle of attack 982. This is indicated by the parallel representation of the upper and lower control loops.

FIG. 10 depicts a control loop 1088 that adjusts the wing assembly pitch 546 to achieve a target energy consumption, according to an embodiment of the principles described herein. As described above, in some examples, the wing assembly pitch adjustments may be based on another type of target wing assembly pitch, one that is indirectly calculated based on an input objective. For example, a pilot may input a target “mode” (e.g., an energy consumption mode) for the aircraft 100, where the target wing assembly pitch 1090 is adjusted to achieve a particular goal. In the example depicted in FIG. 10, the wing assembly pitch 546 is adjusted to actively achieve a target energy consumption, e.g., a minimal battery current or fuel flow. In the example depicted in FIG. 10, the control loop 1088 utilizes a derivative (i.e., δ) of energy consumption to determine the target wing assembly pitch 1090. Accordingly, the tilt actuator control system 102 may activate the tilt actuator 104 to align the wing assembly pitch 546 with a target wing assembly pitch 1090 that corresponds to a wing assembly pitch where energy consumption matches a target value, such as a minimum value.

As depicted, per the control loop 1088 of FIG. 10, the system takes a derivative (i.e., δ) of energy consumption over time. Note that this derivative of energy is taken with respect to the wing assembly pitch 546, which is different from other summation or integration elements, which may be taken with respect to time. In general, taking the derivative converges at a point where the rate of change of energy versus wing assembly pitch 546 is zero, which may indicate that target energy consumption (e.g., the minimum energy consumption) is achieved.

In some examples, the derivative may be subjected to processing, filtering, or other conditioning (e.g., “gain”) to enhance the difference signal. The derivative may be mapped to a target wing assembly pitch 1090. In other words, the target wing assembly pitch 1090 in the example of FIG. 10 represents a target pitch where a target energy consumption (e.g., an energy consumption minimum) was achieved.

In the control loop 1088, the tilt actuator module 336 sums (e.g., “Σ”) the target wing assembly pitch 1090 and the wing assembly pitch 546. The summation indicates a difference between the two.

In an example, the difference may be converted into a tilt actuator command 874, which is a command signal for the tilt actuator 104 to operate in a manner that places the wing assembly 106 at a position to reduce the energy consumption of the aircraft 100. The size of the difference may define the tilt actuator command 874. For example, when the wing assembly pitch 546 matches the target wing assembly pitch 1090, no tilt actuator command 874 may be generated. As the difference between the two increases, the tilt actuator command 874 may be adjusted to match the degree of difference.

In the example depicted in FIG. 10, the control loop 1088 prescribes a smoothing function to prevent superfluous adjustments and/or jerky flight control. This smoothing out may eliminate steady-state angular error and may be less prone to oscillation than a proportional control.

In the example depicted in FIG. 10, a time-dependent summation is calculated by integrating (e.g., ∫) the summation of the difference between the wing assembly pitch 546 and the target wing assembly pitch 1090. In some examples, the integrated difference is subjected to processing, filtering, or other conditioning (e.g., “gain”) to enhance the difference signal. The smoothed difference signal may be converted into the tilt actuator command 874 and transmitted to the tilt actuator module 336.

FIG. 11 illustrates a control loop 1192 that adjusts the wing assembly pitch 546 based on a measurable factor 1194, in accordance with an embodiment of the principles described herein. That is, in the example depicted in FIG. 11, the target wing assembly pitch 1090 can be prescribed a priori based on a variety of measurable factors 1194 such as airspeed, altitude, wing assembly pitch 546, and uncompensated fuselage attitude. For example, as described above, the target wing assembly pitch 1090 may be determined based on information included in a lookup table. That is, the lookup table may map the various measurable factors 1194, such as airspeed, altitude, wing assembly pitch 546, and uncompensated fuselage attitude to a target wing assembly pitch 1090. While reference is made to specific measurable factors 1194, the tilt actuator control system 102 may map any, or multiple, of these measurable factors 1194 and other measurable factors to a target wing assembly pitch 1090.

From there, the tilt actuator control system 102 executes the control loop 1192 as described above. Specifically, the system sums (e.g., “Σ”) the lookup table-based target wing assembly pitch 1090 and the wing assembly pitch 546. The summation indicates a difference between the two.

In the example depicted in FIG. 11, the control loop 1192 prescribes a smoothing function to prevent superfluous adjustments and/or jerky flight control. This smoothing out may eliminate steady-state angular error and may be less prone to oscillation than a proportional control.

In some examples, the integrated difference is subjected to processing, filtering, or other conditioning (e.g., “gain”) to enhance the difference signal. The smoothed difference signal may be converted into the tilt actuator command 874 and transmitted to the tilt actuator module 336.

As in the above case, the tilt actuator command 874 may be defined by the size of the difference. For example, when the wing assembly pitch 546 matches the lookup table-based target wing assembly pitch 1090, no tilt actuator command 874 may be generated. As the difference between the two increases, the tilt actuator command 874 may be adjusted to match the degree of difference.

Note that while FIGS. 8-11 depict specific examples of control loops, a variety of different control structures may be implemented in accordance with the principles described herein.

As such, the present tilt actuator control system 102 enhances the lift and operational efficiency of a variable incidence wing aircraft 100 by adjusting the wing assembly pitch 546 during horizontal, cruising, and non-transition flight.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-11, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components, and/or processes also can be embedded in a machine-readable storage, such as a computer program product or other data program storage device, readable by a machine, tangibly embodying a program of instructions executable by the machine to perform methods and processes described herein. These elements can also be embedded in an application product that comprises the features enabling the implementation of the methods described herein and which, when loaded in a processing system, is able to carry out these methods.

Furthermore, arrangements described herein may take the form of a computer program product embodied in one or more machine-readable media having machine-readable program code embodied, e.g., stored, thereon. Any combination of one or more machine-readable media may be utilized. The phrase “machine-readable storage medium” means a non-transitory storage medium. A machine-readable storage medium may be, for example, but not limited to, an electronic, magnetic, optical, electromagnetic, infrared, or semiconductor system, apparatus, or device, or any suitable combination of the foregoing. A non-exhaustive list of the machine-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a machine-readable storage medium is, for example, a tangible medium that stores a program for use by or in connection with an instruction execution system, apparatus, or device.

Program code embodied on a machine-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
determine, based on an input objective, a target wing assembly pitch for a wing assembly of an aircraft, the wing assembly of the aircraft rotates about a pitch axis of a fuselage via action of a tilt actuator;
measure a wing assembly pitch of the wing assembly; and
alter an angle of the wing assembly based on a difference between the target wing assembly pitch and the wing assembly pitch.

2. The system of claim 1, wherein the memory further stores a machine-readable instruction that, when executed by the processor, causes the processor to, responsive to an alteration of the angle of the wing assembly, alter an angle of a control surface to maintain a target fuselage pitch.

3. The system of claim 1, wherein the memory further stores machine-readable instructions that, when executed by the processor, cause the processor to:
detect that the wing assembly has reached its operational threshold;
determine, based on the input objective, a target fuselage pitch for the fuselage;
measure a fuselage pitch of the fuselage;
alter a fuselage control surface angle based on a difference between the target fuselage pitch and the fuselage pitch; and
alter the angle of the wing assembly to maintain the wing assembly within its operational threshold.

4. The system of claim 1, wherein the machine-readable instruction that causes the processor to alter the angle of the wing assembly based on a detected difference comprises at least one of:
a machine-readable instruction that causes the processor to alter the angle of the wing assembly so the wing assembly pitch is more positively pitched than the fuselage; or
a machine-readable instruction that causes the processor to alter the angle of the wing assembly such that the wing assembly pitch is more negatively pitched than the fuselage.

5. The system of claim 1, wherein the input objective is at least one of:
a target energy consumption during horizontal flight;
a target range during horizontal flight;
a target speed during horizontal flight; or
a target aerodynamic condition during horizontal flight.

6. The system of claim 1, wherein the memory further comprises machine-readable instructions that, when executed by the processor, cause the processor to:
monitor a metric indicative of a state of the input objective; and
select, as the target wing assembly pitch, the wing assembly pitch that results in the metric being at least one of a maximum value, a minimum value, or a predetermined value.

7. The system of claim 1, wherein the memory further comprises machine-readable instructions that, when executed by the processor, cause the processor to determine the input objective based on a manipulation of a flight control input from a pilot.

8. The system of claim 1, wherein the memory further comprises a machine-readable instruction that, when executed by the processor, causes the processor to identify the input objective based on user selection of the input objective from a set of candidate objectives.

9. A non-transitory machine-readable medium comprising instructions that, when executed by a processor, cause the processor to:
determine, based on an input objective, a target wing assembly pitch for a wing assembly of an aircraft, the wing assembly of the aircraft rotates about a pitch axis of a fuselage via action of a tilt actuator;
measure a wing assembly pitch of the wing assembly; and
alter an angle of the wing assembly based on a difference between the target wing assembly pitch and the wing assembly pitch.

10. The non-transitory machine-readable medium of claim 9, wherein the non-transitory machine-readable medium further comprises an instruction that, when executed by the processor, causes the processor to, responsive to an alteration of the angle of the wing assembly, alter an angle of a control surface to maintain a fuselage pitch angle.

11. The non-transitory machine-readable medium of claim 9, wherein the non-transitory machine-readable medium further comprises instructions that, when executed by the processor, cause the processor to:
detect that the wing assembly has reached its operational threshold;
determine, based on the input objective, a target fuselage pitch for the fuselage;
measure a fuselage pitch of the fuselage;
alter a fuselage control surface angle based on a difference between the target fuselage pitch and the fuselage pitch; and
alter the angle of the wing assembly to maintain the wing assembly within its operational threshold.

12. The non-transitory machine-readable medium of claim 9, wherein the input objective is at least one of:
a target energy consumption during horizontal flight;
a target range during horizontal flight;
a target speed during horizontal flight; or
a target aerodynamic condition during horizontal flight.

13. The non-transitory machine-readable medium of claim 9, wherein the non-transitory machine-readable medium further comprises instructions that, when executed by the processor, cause the processor to:
monitor a metric indicative of a state of the input objective; and
select, as the target wing assembly pitch, the wing assembly pitch that results in the metric being at least one of a maximum value, a minimum value, or a predetermined value.

14. The non-transitory machine-readable medium of claim 9, wherein the non-transitory machine-readable medium further comprises instructions that, when executed by the processor, cause the processor to determine the input objective based on a manipulation of a flight control input from a pilot.

15. A method, comprising:
determining, based on an input objective, a target wing assembly pitch for a wing assembly of an aircraft, the wing assembly of the aircraft rotates about a pitch axis of a fuselage via action of a tilt actuator;
measuring a wing assembly pitch of the wing assembly; and
altering an angle of the wing assembly based on a difference between the target wing assembly pitch and the wing assembly pitch.

16. The method of claim 15, further comprising, responsive to an alteration of the angle of the wing assembly, altering an angle of a control surface to maintain a fuselage pitch angle.

17. The method of claim 15, further comprising:
detecting that the wing assembly has reached its operational threshold;
determining, based on the input objective, a target fuselage pitch for the fuselage;
measuring a fuselage pitch of the fuselage;
altering a fuselage control surface angle based on a difference between the target fuselage pitch and the fuselage pitch; and
altering the angle of the wing assembly to maintain the wing assembly within its operational threshold.

18. The method of claim 15, wherein the input objective is at least one of:
a target energy consumption during horizontal flight;
a target range during horizontal flight;
a target speed during horizontal flight; or
a target aerodynamic condition during horizontal flight.

19. The method of claim 15, further comprising:
monitoring a metric indicative of a state of the input objective; and
selecting, as the target wing assembly pitch, the wing assembly pitch that results in the metric being at least one of a maximum value, a minimum value, or a predetermined value.

20. The method of claim 15, further comprising determining the input objective based on a manipulation of a flight control input from a pilot.
